(19) United States
(12) Patent Application Publication
(10) Pub. No.: US 2004/0226588 A1
(43) Pub. Date: Nov. 18, 2004

(54) Cleaning apparatus

(75) Inventors: Takashi Onishi, Kobe-shi (JP); Tetsuya Yoshikawa, Takasago-shi (JP); Shogo Sarumaru, Takasago-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Kabushiki Kaisha Kobe Seiko Sho(Kobe Steel, Ltd.), Kobe-shi (JP)

(21) Appl. No.: 10/836,235

(22) Filed: May 3, 2004

(30) Foreign Application Priority Data
May 15, 2003 (JP) 2003-137679

(51) Int. Cl. B08B 3/00

(52) U.S. Cl. 134/186; 134/200; 134/902

(57) ABSTRACT

The corrosion resistance against hydrogen fluoride of a cleaning apparatus using a high-pressure fluid is markedly improved by making at least the surfaces of portions in contact with hydrogen fluoride out of a Fe-based alloy or Ni-based alloy containing a predetermined amount of Cr. Even when cleaning is carried out with the high-pressure fluid containing hydrogen fluoride by this cleaning apparatus, the apparatus has excellent durability and is free from the eluation of a metal which causes the deterioration of a micro-structure as an object to be cleaned.

### BACKGROUND OF THE INVENTION

1. Field of the Invention

The present invention relates to a treating apparatus for applying a high-pressure fluid such as a supercritical fluid to a micro-structure having fine irregularities on the surface such as a semiconductor wafer, e.g., a cleaning apparatus for dissolving, separating and removing the residual resist, etc. from a semiconductor wafer in the process for manufacturing a semiconductor.

2. Description of the Prior Art

Since a trace amount of an impurity causes a product defect in a semiconductor or precision part having fine irregularities on the surface (to be referred to as “micro-structure” hereinafter), a cleaning step is very important in its manufacturing process.

For example, in the semiconductor manufacturing process, the removal of an unnecessary substance adhered to a semiconductor wafer is requisite. The patterning step on a semiconductor wafer with a resist is often used to manufacture a semiconductor. After etching, the resist which has been used for masking and is not necessary any more is removed by ashing with oxygen plasma (ashing step). After the ashing step, a cleaning step for separating and removing undesired substances such as the residue in the etching step and the residual resist which could not be removed in the ashing step from the surface of the wafer is necessary. This cleaning step is an important step which is often carried out in the semiconductor manufacturing process and not only after the ashing step.

Recently, studies of a high-pressure fluid such as a supercritical fluid as the medium of a cleaning solution and rinsing solution in the cleaning step are made. A further shrinkage in the size of a micro-structure is desired for the reason that the integration of a semiconductor product is being improved by technical progress. The supercritical fluid shows much higher permeability than a liquid and can permeate even a micro-structure. Since it has no interface between gas and liquid, capillary force does not work at the time of drying and it does not destroy the above resist. Further, as the supercritical fluid becomes gaseous by reducing pressure, the drying step can be very easily carried out.

As cleaning techniques for a micro-structure with a supercritical fluid, U.S. Pat. No. 5,105,556 discloses a method for extracting and removing a contaminant by bringing a supercritical fluid (supercritical gas in this document) into contact with a semiconductor wafer and enumerates hydrogen fluoride and hydrogen chloride as a reactive gas to be mixed with the supercritical gas in order to remove an unnecessary substance (SiO₂).

The applicant found that a supercritical fluid comprising carbon dioxide and hydrogen fluoride is the best suited for maintaining quality and efficiently removing an unnecessary substance in the cleaning of a semiconductor wafer having an interlaminar insulating film having a low dielectric constant (Low-k film) which is now frequently used, and that damage to the Low-k film can be reduced when water and/or alcohol are/is added to the supercritical fluid.

However, since hydrogen fluoride is highly corrosive and the temperature and pressure must be increased higher than the critical points in order to form a supercritical fluid and a metal portion in contact with the supercritical fluid of a cleaning apparatus is corroded, the durability of the apparatus cannot be secured. In addition, the micro-structure adsorbs a metal ion dissolved by corrosion adheres to, thereby reducing product quality.

JP-A 10-94767 (the term “JP-A” as used herein means an “unexamined published Japanese patent application”) discloses a supercritical fluid cleaning apparatus for cleaning an object with a cleaning solvent in a supercritical state as an apparatus for cleaning a micro-structure with a supercritical fluid and enumerates carbon dioxide as a cleaning solvent. However, this publication is utterly silent about other cleaning components and does not take into consideration corrosion resistance against hydrogen fluoride.

JP-A 2002-20706 discloses a reactor which has excellent corrosion resistance and is used for the production of hydrogen fluoride and at least part of which is made of a metal material containing chromium and 30 to 90 mass % of tungsten carbide. However, this reactor may be durable enough to reduce the abrasion of a portion for providing shear force to hydrogen fluoride and its materials (metal fluoride, sulfuric acid, fuming sulfuric acid, water) and does not take into consideration the elution of a trace amount of metal which causes a problem in the micro-structure. Therefore, if the material of the reactor is used in an apparatus for cleaning a micro-structure, product quality may be deteriorated by metal contaminants.

### SUMMARY OF THE INVENTION

As described above, although there has been existent a metal material which is said to have durability against hydrogen fluoride, a metal material which is used under an extreme condition that a high-pressure fluid such as a supercritical fluid can be retained and best suited for the manufacture of a micro-structure whose quality is reduced by a trace amount of a metal contaminant is not existent.

It is therefore an object of the present invention to provide a cleaning apparatus which has excellent durability and is free from the eluation of a metal which reduces the quality of a micro-structure as an object to be cleaned.

The inventors of the present invention have prepared various alloys to solve the above problem and have conducted intensive studies to obtain a material which shows high corrosion resistance against hydrogen fluoride. As a result, they have found that a Fe-based alloy or Ni-based alloy containing a fixed amount of Cr shows high corrosion resistance and does not form a metal contaminant even when it is used in an apparatus for cleaning a micro-structure with a high-pressure fluid containing hydrogen fluoride. The present invention has been accomplished based on this finding.

That is, the cleaning apparatus of the present invention is an apparatus for cleaning an object to be cleaned with a high-pressure fluid, comprising: a high-pressure vessel for cleaning the object with the high-pressure fluid therein; cleaning additive supply means for supplying a cleaning additive to be added to the high-pressure fluid at the time of cleaning to the high-pressure fluid; and a piping system through which the high-pressure fluid containing the cleaning additive is supplied into the high-pressure vessel or discharged from the high-pressure vessel, wherein at least the surfaces of portions in contact with the cleaning additive on an upstream side of the high-pressure vessel of the piping system and a portion in contact with the cleaning additive of the high-pressure vessel are made of a Fe-based alloy containing more than 20 mass % of Cr.

In the above cleaning apparatus, hydrogen fluoride may be used as the cleaning additive.

In the above cleaning apparatus, substantially all of the portions in contact with the cleaning additive of the high-pressure vessel and the piping system are preferably made of a Fe-based alloy containing more than 20 mass % of Cr. Alternatively, the surfaces of the portions in contact with the cleaning additive of the high-pressure vessel and the piping system are coated with a Fe-based alloy containing more than 20 mass % of Cr.

Alternatively, the cleaning apparatus of the present invention is an apparatus for cleaning an object to be cleaned with a high-pressure fluid, comprising: a high-pressure vessel for cleaning the object with the high-pressure fluid therein; cleaning additive supply means for supplying a cleaning additive to be added to the high-pressure fluid at the time of cleaning to the high-pressure fluid; and a piping system through which the high-pressure fluid containing the cleaning additive is supplied into the high-pressure vessel or discharged from the high-pressure vessel, wherein at least the surfaces of portions in contact with the cleaning additive on an upstream side of the high-pressure vessel of the piping system and a portion in contact with the cleaning additive of the high-pressure vessel are made of a Ni-based alloy containing more than 40 mass % of Cr.

In the above cleaning apparatus, hydrogen fluoride may be used as the cleaning additive.

In the above cleaning apparatus, substantially all the portions in contact with the cleaning additive of the high-pressure vessel and the piping system are preferably made of a Ni-based alloy containing more than 40 mass % of Cr.

Alternatively, the surfaces of the portions in contact with the cleaning additive of the high-pressure vessel and the piping system are coated with a Ni-based alloy containing more than 40 mass % of Cr.

According to the present invention, there is also provided a high-pressure vessel for cleaning an object to be cleaned with a high-pressure fluid therein, wherein

at least the surface of a portion in contact with the high-pressure fluid of the high-pressure vessel is made of a Fe-based alloy containing more than 20 mass % of Cr or a Ni-based alloy containing more than 40 mass % of Cr.

Although the reason why the cleaning apparatus of the present invention shows extremely high corrosion resistance against hydrogen fluoride contained in the high-pressure fluid is not made clear, it is considered that it is due to chromia (Cr₂O₃, a simple body of chromium oxide) formed on the surface by Cr which is an essential ingredient. That is, although a Fe oxide (Ni oxide in the case of the Ni-based alloy) is generally formed on the surface in the case of a Fe-based alloy, when a fixed amount or more of Cr is added, Cr forms a uniform thin laminar oxide layer (Cr₂O₃) by itself. As this Cr₂O₃ forms a passive layer having high barrier properties, it is assumed that the film shows extremely marked corrosion resistance against a supercritical fluid containing hydrogen fluoride.

In the above two different cleaning apparatuses, substantially all the portions in contact with hydrogen fluoride are preferably made of a Fe-based alloy containing more than 20 mass % of Cr or a Ni-based alloy containing more than 40 mass % of Cr. This is because the durability of the apparatuses becomes higher than when only the surfaces of portions in contact with hydrogen fluoride are made of the above alloy.

Since the corrosion resistance against hydrogen fluoride of the cleaning apparatus of the present invention is obtained even in an environment for forming a supercritical fluid, the cleaning apparatus has excellent durability, is free from metal contamination to reduce product quality in the step of cleaning a micro-structure and can retain the quality of the micro-structure.

Therefore, the cleaning apparatus of the present invention is extremely useful in the industrial field because it enables the manufacture of a high-quality micro-structure even when the step of cleaning with hydrogen fluoride is carried out.

### BRIEF DESCRIPTION OF THE DRAWING

FIG. 1 is a conceptual diagram of a cleaning apparatus according to an embodiment of the present invention.

### DETAILED DESCRIPTION OF THE PREFERRED EMBODIMENT

The biggest feature of the cleaning apparatus of the present invention is that although the cleaning apparatus cleans a micro-structure with a high-pressure fluid containing hydrogen fluoride, it has excellent durability, rarely forms a metal contaminant by the eluation of a metal ion and does not reduce the quality of a product.

There have been known a method of cleaning a micro-structure such as a semiconductor wafer with a high-pressure fluid which may contain hydrogen fluoride and a cleaning apparatus using a supercritical fluid. However, thorough studies on an apparatus for cleaning with a high-pressure fluid containing hydrogen fluoride have not been made. Therefore, when this conventional apparatus is used for cleaning with such a fluid, it deteriorates in durability and involves a problem that a metal ion derived from the apparatus adheres to the micro-structure, thereby reducing product quality, though an extremely high cleaning effect is obtained.

However, the inventors of the present invention have found that the above problem can be solved by specifying a material for portions which cause the metal contamination of the cleaning apparatus and have accomplished the present invention.

A preferred embodiment of the present invention which has the above feature and its effect will be described hereinunder.

The apparatus of the present invention is an apparatus for cleaning a micro-structure by bringing a high-pressure fluid containing hydrogen fluoride into contact with the micro-structure.

The high-pressure fluid used for the cleaning of the micro-structure preferably contains supercritical carbon dioxide as the main component. The reason that carbon dioxide is the main component is that a dissolved unnecessary substance having a large diffusion coefficient can be easily dispersed in a medium and that a supercritical fluid can be relatively easily prepared (7.1 MPa or more at 31° C. or higher).

It is preferred that water, an alcohol, etc. should be added to the supercritical fluid in addition to hydrogen fluoride as a cleaning component to clean the micro-structure. The hydrogen fluoride, etc. do not form a supercritical fluid near the supercritical point (7.1 MPa or more at 31° C. or higher) of the above carbon dioxide and it is unknown in what state they are. It is assumed that they are dissolved or dispersed in carbon dioxide in a supercritical state in an amount that at least the effect of the present invention is obtained and it is considered that they further improve a cleaning effect.

The reason that hydrogen fluoride is used as a cleaning component is that high cleaning efficiency is obtained while damage to a Low-k film in particular is suppressed. In the cleaning apparatus of the present invention, even when a micro-structure is cleaned with hydrogen fluoride, a metal contaminant that reduces product quality is rarely produced. Therefore, the present invention can be clearly distinguished from the prior art in terms of effect. Gaseous hydrogen fluoride may be supplied to carbon dioxide, etc. in a supercritical state, or hydrofluoric acid which is an aqueous solution of hydrogen fluoride may be mixed with carbon dioxide in a supercritical state. If an alcohol is caused to be existent in this system, the dissolution or dispersion of hydrogen fluoride in the supercritical fluid is made easy. When hydrofluoric acid is used, the amount of hydrofluoric acid to be supplied to carbon dioxide, etc. in a supercritical state may be controlled to adjust the content of hydrogen fluoride in the cleaning composition. Therefore, in this case, the control of supply becomes easier than when gaseous hydrogen fluoride is supplied to carbon dioxide in a supercritical state. To develop these effects suitably, the content of hydrogen fluoride in the cleaning composition is preferably set to 0.0001 to 0.5 mass %.

The reason that water and an alcohol are added is that damage to the micro-structure is further reduced. The alcohol has compatibilizing effects that hydrogen fluoride is easily mixed into the supercritical fluid and that an unnecessary substance which is hardly soluble in water and carbon dioxide in a supercritical state is easily made soluble. To develop the above damage reduction effect and compatibilizing effects, the alcohol is preferably contained in the cleaning composition in an amount of 1 mass % or more. The more preferred lower limit is 2 mass %. The upper limit is not particularly limited. However, when the alcohol is contained too much, the amount of carbon dioxide which is a cleaning medium is reduced and excellent permeability derived from carbon dioxide in a supercritical state is hardly obtained. The upper limit is preferably 20 mass %, more preferably 10 mass %. Water may be mixed with hydrogen fluoride to prepare hydrofluoric acid to be introduced into a high-pressure vessel.

Examples of the alcohol include methanol, ethanol, n-propanol, isopropanol, n-butanol, isobutanol, diethylene glycol monomethyl ether, diethylene glycol monoethyl ether and hexafluoroisopropanol.

A typical example of the micro-structure to be cleaned in the present invention is a semiconductor wafer to which an unnecessary substance such as the residual resist after ashing is adhered to a fine uneven portion.

It is considered that the residual resist contains an inorganic polymer formed from a resist polymer through the ashing step, modified product of the resist polymer by fluorine contained in an etching gas, modified product of a polyimide used in an anti-reflection film, etc. The cleaning apparatus of the present invention is suitable for removing the residual resist after ashing.

As a matter of course, the cleaning apparatus of the present invention is used to remove not only the residual resist but also substances to be removed other than the residual resist, which are existent on the semiconductor wafer in the semiconductor wafer manufacturing process. For example, the cleaning apparatus of the present invention can be advantageously used to remove a resist before ashing, the resist after implantation and the residue after CMP (Chemical Mechanical Polishing) existent on the flat surface of a wafer as fine projections from the surface of the semiconductor wafer.

The position where the above substances to be removed are existent is not only the surface of the semiconductor wafer. That is, the cleaning apparatus of the present invention can be advantageously used to remove a interlaminar film such as SiO₂ or organic low-dielectric film used to form a micro-structure having a stacked interconnection, and to extract and remove an unnecessary solvent remaining in the interlaminar insulating film when a coated type interlaminar insulating film having a low dielectric constant is to be formed.

That is, the cleaning step carried out by the cleaning apparatus of the present invention includes not only the step of removing the above residual resist but also the step of removing a interlaminar film formed from the surface layer to the interior of the semiconductor wafer and also the step of removing unnecessary substances dispersed, adsorbed and remaining in the stacked interconnection. The term “adhesion” is not limited to adhesion to the surface layer but also means that a substance is dispersed, adsorbed and remain in the interior, that is, various existence states of an unnecessary substance in the manufacture of a micro-structure.

The micro-structure to be cleaned with the cleaning apparatus of the present invention is not limited to a semiconductor wafer but includes what has a fine pattern on the surface of a substrate made of metal, plastic, ceramic, etc. and a substance to be removed adhered or remaining on the surface of the pattern.

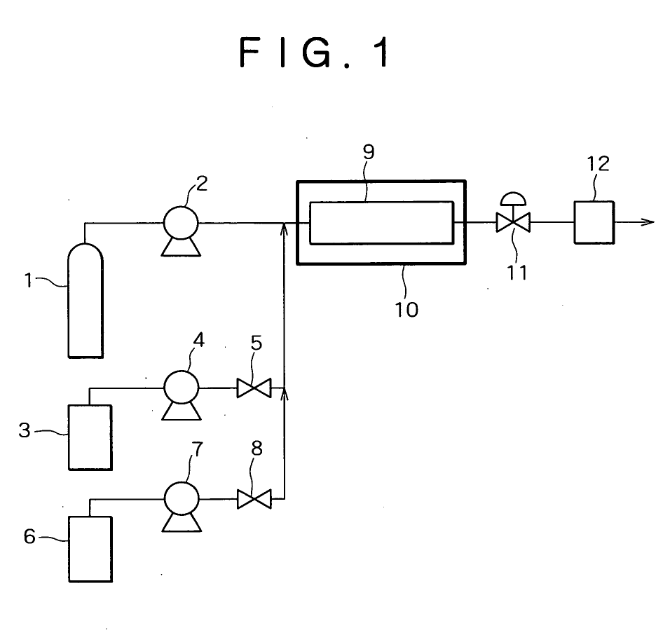

The cleaning apparatus of the present invention will be described with reference to FIG. 1 which is a conceptual diagram of an embodiment of the present invention and does not limit the scope of the invention. The constitution of the apparatus may be modified with known means.

In FIG. 1, reference numerals 1, 3 and 6 denote a carbon dioxide cylinder, hydrofluoric acid tank and alcohol tank, respectively, and these contents are supplied into a high-pressure vessel 9 in a liquid form. The temperature and pressure of the introduced carbon dioxide are increased to values higher than their critical points by an isothermal tank 10 and a pressure control valve 11 to prepare a supercritical fluid which is used to clean a micro-structure together with hydrogen fluoride in order to remove unnecessary substances.

To carry out the cleaning step with the cleaning apparatus of FIG. 1, an object to be cleaned (micro-structure) is first introduced into the high-pressure vessel 9 from an unshown opening/closing portion. Then, carbon dioxide supplied from the carbon dioxide cylinder 1 is pressurized by a carbon dioxide feed pump 2 to be supplied into the high-pressure vessel 9 where the pressure of the carbon dioxide is adjusted to a value higher than its critical point by the pressure control valve 11 and its temperature is set to a predetermined temperature (higher than the critical temperature) by the isothermal tank 10. Hydrofluoric acid and an alcohol which are cleaning components (cleaning additives) are introduced into the high-pressure vessel 9 from the tanks 3 and 6 by pumps 4 and 7, respectively, and dispersed into the supercritical fluid to start the cleaning step. The supply of carbon dioxide and the cleaning components may be carried out continuously or the supply of these is stopped when a fixed pressure is reached (or the supply is stopped and these components are circulated). The high-pressure vessel 9 may be equipped with a heater in place of the above isothermal tank 10.

The temperature of the cleaning step is preferably 20 to 120° C. under the condition that it is higher than the critical point. Below 20° C., the cleaning time becomes long, thereby reducing efficiency. Since the critical temperature of carbon dioxide is 31° C., the temperature must be set higher than 31° C. Above 120° C., the further improvement of cleaning efficiency is not observed, resulting in the waste of energy. The upper limit of the temperature is more preferably 100° C., much more preferably 80° C.

The cleaning time may be suitably changed according to the size of an object to be cleaned or the amount of a contaminant. When the object to be cleaned is a Low-k film, if it is cleaned too long, damage to the film becomes large and cleaning efficiency becomes low. The cleaning time for a single ordinary wafer is preferably 3 minutes or less, more preferably 2 minutes or less.

In the present invention, at least the surfaces of portions in contact with hydrogen fluoride of the above cleaning apparatus are made of a Fe-based alloy containing more than 20 mass % of Cr or a Ni-based alloy containing 40 mass % or more of Cr. These alloys have extremely high corrosion resistance to hydrogen fluoride and are therefore extremely useful as materials for the apparatus for the process for manufacturing a micro-structure in which a trace metal contaminant causes a reduction in product quality.

That is, during the cleaning of a micro-structure with a high-pressure fluid containing hydrogen fluoride, the cleaning apparatus may be exposed to highly corrosive hydrogen fluoride at least under the conditions of a temperature higher than the critical temperature and a pressure higher than the critical pressure. Therefore, the surface of the apparatus may be corroded and metal ions may elute and contaminate the micro-structure. However, when portions exposed to such severe conditions are made of the alloy of the present invention, the metal contamination of the micro-structure can be markedly suppressed and the durability of the apparatus can be improved.

The “Fe-based alloy” and “Ni-based alloy” refer to alloys having largest contents of Fe and Ni out of elements constituting these alloys excluding an impurity element inevitably contained, respectively. A gas component element is excluded from the constituent elements.

The expression “at least the surfaces of portions in contact with hydrogen fluoride” means that only the surfaces of portions in contact with hydrogen fluoride may be coated with the alloy having excellent corrosion resistance of the present invention or substantially all the portions may be made of the alloy of the present invention. When substantially all the above portions in contact with hydrogen fluoride are made of the alloy of the present invention, the durability of the cleaning apparatus can be further improved.

The “portions in contact with hydrogen fluoride” include not only portions in contact with the high-pressure fluid but also portions in contact with hydrogen fluoride at normal temperature and normal pressure.

The apparatus for cleaning a micro-structure with a high-pressure fluid has portions in contact with hydrogen fluoride which are made of a resin material and not a metal, such as parts of a valve and a joint. Since the present invention is directed to the specification of the components of a metal material, the “portions in contact with hydrogen fluoride” in the present invention do not include portions made of a material other than metal.

The “portions in contact with hydrogen fluoride” in the present invention are, for example, a high-pressure vessel for cleaning a micro-structure actually, pipes, etc of the cleaning apparatus. Portions which may be made of a resin, such as a sealing member and portions on a downstream side of the high-pressure vessel which do not cause metal contamination may be made of another type of alloy or material other than metal even though they are the “portions in contact with hydrogen fluoride”.

When all the “portions in contact with hydrogen fluoride” in the present invention are to be substantially made of an alloy specified by the present invention, to produce the portions, the composition of constituent components is made as desired in the manufacturing process of an ingot and a alloy plate or the like is manufactured from the ingot and processed into a predetermined form by extrusion molding or mechanical processing. The above portions can be manufactured by casting or forging and their manufacturing methods are not particularly limited if the composition of the alloy falls within the scope of the present invention. Further, to make the surfaces of the “portions in contact with hydrogen fluoride” out of the alloy of the present invention, portions molded from other metal material may be coated with a thin film of the alloy of the present invention. This coating can be formed by physical vapor deposition (vacuum vapor deposition or sputtering) or electroplating. The thickness of the coating layer is not particularly limited but preferably 1 μm or more, more preferably 10 μm or more to obtain sufficiently high durability.

The content of Cr in the Fe-based alloy must be more than 20 mass % and the lower limit is preferably 21 mass %, more preferably 22 mass %.

As for alloying elements of the present invention, alloying elements other than Cr and Fe or Cr and Ni are not particularly limited if the above conditions are satisfied. Besides impurities contained inevitably, components used to improve the moldability and strength of the apparatus members may be added. At least one alloying element selected from Al, Fe (in the base of a Ni-based alloy), Cu, Zn, W, Mo, Si, Ta, Nb, Mn and Ti may be used as the alloying element.

The present invention is constituted as described above. Since the eluation of a metal ion caused by hydrogen fluoride in a supercritical state is markedly suppressed in the cleaning apparatus of the present invention, when the micro-structure is cleaned with the apparatus of the present invention, a micro-structure having extremely high quality can be manufactured.

The following examples are provided for the purpose of further illustrating the present invention but are in no way to be taken as limiting.

### EXAMPLES

### Example 1

A Fe-based or Ni-based alloy was processed into a specimen (coupon)-like form as a sample and this specimen was immersed in a liquid composition containing hydrogen fluoride as a simulation of exposing to hydrogen fluoride at an increased temperature and an increased pressure so as to measure a reduction in the weight of the specimen before and after immersion. Thus, corrosion resistance was evaluated.

After Ni-based alloy Nos. 1 to 4 and Fe-based alloy Nos. 5 to 8 shown in Table 1 were selected as the materials to be tested and cut into plates measuring 25×20×1.0 t (mm), the both surfaces of each plate were mechanically polished to a surface roughness of 1.6 s and further subjected to buff polishing and electric polishing to prepare specimens. Thereby, both sides of each specimen became mirror surfaces. The specimens were washed in pure water, cleaned with IPA (isopropyl alcohol) and dried in air.

A test solution composed of hydrogen fluoride, water and ethanol in a weight ratio of 1:1:98 was prepared and used.

A fluororesin wide-mouthed lidded bottle having a capacity of 250 ml was used as a test vessel. The test vessel was immersed in hydrochloric acid for 4 hours or more and then in nitric acid for 4 hours or more, washed in pure water and dried in air.

After the initial weights of the specimens shown in Table 1 were measured (with an automatic balance), they were inserted into the above test vessel, 100 ml of the above liquid composition was poured into the test vessel, and the test vessel was closed airtight to carry out an immersion test at 70° C. for 168 hours. The test vessel was placed in an isothermal water tank which was controlled at a fixed temperature of 70° C.

After the passage of 168 hours, the specimens were taken out from the test vessel, washed in pure water, cleaned with IPA and dried in air to measure their weights (with an automatic balance) The results are shown in Table 1.

TABLE 1

| | Composition of alloy (mass %) | | | | | Corrosion weight | |
|---|---|---|---|---|---|---|---|
| No. | Ni | Cr | Mo | W | Fe | reduction (g) | Judgment |
| 1 | 54.0 | 45.0 | 1.0 | | | 0 | accepted |
| 2 | 59.0 | 22.0 | 13.0 | 3.0 | 3.0 | 0.0025 | not accepted |
| 3 | 62.0 | 19.0 | 19.0 | | | 0.0028 | not accepted |
| 4 | 63.0 | 16.0 | 16.0 | | 5.0 | 0.0068 | not accepted |
| 5 | 6.3 | 25.0 | 3.3 | | 65.4 | 0.0014 | accepted |
| 6 | 4.0 | 17.0 | | | 79.0 | 0.0227 | not accepted |
| 7 | 12.0 | 17.0 | 2.0 | | 69.0 | 0.0067 | not accepted |
| 8 | 10.0 | 19.0 | | | 71.0 | 0.0092 | not accepted |

The weights of the specimens were about 5 to 6 g. To actually use these specimens in a portion in contact with hydrogen fluoride of the apparatus for cleaning a micro-structure, the corrosion weight reduction must be reduced to 0.002 g.

It is understood from the above results that alloy No.1 out of Ni-based alloy Nos. 1 to 4 has extremely excellent corrosion resistance with a corrosion weight reduction smaller than the detection limit. It is also found that alloy No. 5 out of Fe-based alloy Nos. 5 to 8 has excellent corrosion resistance with a corrosion weight reduction of 0.0014 g. When the content of Cr in a Ni-based alloy is 22.0 mass % or less and the content of Cr in a Fe-based alloy is 19.0 mass % or less, corrosion resistance against hydrogen fluoride is insufficient.

Therefore, it has been made clear that the material for use in an apparatus for cleaning a micro-structure with a supercritical fluid containing hydrogen fluoride is a Ni-based alloy or Fe-based alloy containing a fixed amount of Cr.

### Example 2

Alloys containing no other components excluding inevitable impurities were manufactured by adding a predetermined amount of Cr to Ni or by adding a predetermined amount of Cr to Fe, to carry out the same experiment as in the above Example 1, so as to check the influences upon the corrosion resistance against hydrogen fluoride of the Ni-based alloys and Fe-based alloys of Cr.

Ni—Cr alloys Nos. 11 to 14 and Fe—Cr alloy Nos. 15 to 18 shown in Table 2 were used as test materials and plate-like specimens measuring 25×20×1.0 t (mm) were prepared in the same manner as in Example 1 and subjected to an immersion test. The results are shown in Table 2.

TABLE 2

| | Composition of alloy (mass %) | | | | | Corrosion weight | |
|---|---|---|---|---|---|---|---|
| No. | Ni | Cr | Mo | W | Fe | reduction (g) | Judgment |
| 11 | 55.0 | 45.0 | | | | 0 | accepted |
| 12 | 75.0 | 25.0 | | | | 0.0031 | not accepted |
| 13 | 80.0 | 20.0 | | | | 0.0049 | not accepted |
| 14 | 85.0 | 15.0 | | | | 0.0105 | not accepted |
| 15 | | 25.0 | | | 75.0 | 0.0018 | accepted |
| 16 | | 20.0 | | | 80.0 | 0.0081 | not accepted |
| 17 | | 15.0 | | | 85.0 | 0.0316 | not accepted |
| 18 | | 10.0 | | | 90.0 | 0.1412 | not accepted |

It could be confirmed from the above results that Ni—Cr alloy No. 11 has extremely excellent corrosion resistance with a corrosion weight reduction below the detection limit and that Fe—Cr alloy No. 15 has excellent corrosion resistance with a corrosion weight reduction of 0.0018 g.

On the other hand, Ni—Cr alloy Nos. 12 to 14 which contain 15.0 to 25.0 mass % of Cr and Ni—Cr alloy Nos. 16-18 which contain 10.0 to 20.0 mass % of Cr are unsatisfactory in terms of corrosion resistance with a corrosion weight reduction of more than 0.0020 g.

Therefore, it has been verified that, in the relationship between Cr and Fe only or between Cr and Ni only, a fixed amount of Cr must be added to provide sufficiently high corrosion resistance against hydrogen fluoride.

### Example 3

After an immersion test was made on specimen No. 7 at 70° C. for 168 hours in the above Example 1, the species and concentrations of cations contained in the test solution were analyzed by ICP (induction coupled plasma emission spectrometry). The results are shown in Table 3.

TABLE 3

Detected elements (μg/ml)

| No. | Fe | Ni | Cr | Mo | Si | Mn |
|---|---|---|---|---|---|---|
| 7 | 8.80 | 1.80 | 2.00 | 0.34 | <1 | 0.08 |

It was confirmed from the above results that the cations detected from the test solution are the components (constituent elements) of alloy No. 7, the preferential eluation of a specific element was not observed, and the cations were eluted based on the alloying element ratio (constituent element ratio) of the specimen. Therefore, it was found from a combination of these results and the results of Examples 1 and 2 that it is important to make a portion in contact with hydrogen fluoride of an apparatus for cleaning a micro-structure with a supercritical fluid containing hydrogen fluoride out of a Fe-based alloy or Ni-based alloy containing a predetermined amount of Cr, and that the effect of other element does not have so much influence.

### Example 4

An experiment on the cleaning of a dummy silicon wafer was carried out by using a high-pressure treating apparatus shown in FIG. 1.

That is, the 8-inch dummy silicon wafer was placed in the high-pressure vessel 9, the high-pressure vessel 9 was closed, carbon dioxide was supplied into the high-pressure vessel 9 from the carbon dioxide cylinder 1 filled with liquefied carbon dioxide by the pump 2, and the high-pressure vessel 9 was maintained at 50° C. in the thermostat 10 while its pressure was adjusted to 15 MPa. Thereafter, cleaning components were introduced into the high-pressure vessel 9 from the tanks 3 and 6 by the pumps 4 and 7 to ensure that the composition contained 95.00 mass % of carbon dioxide, 0.05 mass % of hydrogen fluoride, 0.05 mass % of water and 4.90 mass % of ethanol, and the internal pressure of the high-pressure vessel 9 was adjusted to 15 MPa by opening or closing the pressure control valve 11. Cleaning was carried out for 1 minute in this state, first rinsing with carbon dioxide and ethanol in a supercritical state and second rinsing with only carbon dioxide were carried out, the pump 2 was stopped, the pressure control valve 11 was opened to return the inside pressure of the high-pressure vessel 9 to normal pressure, and the dummy silicon wafer was taken out. This cleaning experiment was made by changing the materials of pipes from the switch valve 5 and switch valve 8 to the pressure control valve 11 and the material of the high-pressure vessel 9. Alloy Nos. 1, 5 and 7 were used.

After the cleaning, a suitable amount of dilute hydrofluoric acid was dropped on the wafer taken out from the high-pressure vessel 9 to dissolve all the metal ions (metal contaminants) adhered to the surface of the wafer in the dilute hydrofluoric acid, the species and concentrations of the metal ions contained in the dilute hydrofluoric acid were analyzed by ICP-MASS, and total amount (number of atoms) of the detected ions were calculated from the concentrations. The results are shown in Table 4.

TABLE 4

| Type of | Type and amount (number of atoms) of detected element | | | | | | | | |
|---|---|---|---|---|---|---|---|---|---|
| alloy | Al | Fe | Ni | Cr | Cu | Zn | Na | Ca | K |
| No. 1 | 1.9 × 10¹⁰ | 1.2 × 10⁹ | 3.0 × 10⁸ | 4.0 × 10⁸ | 9.0 × 10⁸ | 3.0 × 10⁸ | 1.4 × 10⁹ | 2.4 × 10⁹ | 8.0 × 10⁸ |
| No. 5 | 1.4 × 10¹⁰ | 5.3 × 10⁹ | 3.6 × 10⁹ | 4.0 × 10⁸ | 4.6 × 10⁹ | 3.0 × 10⁸ | 5.2 × 10⁹ | 6.0 × 10⁹ | 3.3 × 10⁹ |
| No. 7 | 9.6 × 10¹⁰ | 5.8 × 10¹³ | 1.8 × 10¹¹ | 1.6 × 10¹² | 1.2 × 10¹⁰ | 7.0 × 10¹¹ | 6.5 × 10¹⁰ | 3.1 × 10⁹ | 5.2 × 10⁹ |

As shown in the above results, when alloys Nos. 1 and 5 were used in the high-pressure treating apparatus, 10⁹ metal ions were detected. When alloy No. 7 was used in the high-pressure treating apparatus, more than 10¹⁰ metal ions were detected. Particularly, 10¹³ Fe ions were detected. Therefore, it is verified that the cleaning apparatus of the present invention has excellent corrosion resistance against hydrogen fluoride and when a micro-structure is cleaned by this apparatus, it can be cleaned while the contamination of a metal on the surface is markedly suppressed.

What is claimed is:

1. An apparatus for cleaning an object to be cleaned with a high-pressure fluid, comprising:
a high-pressure vessel for cleaning the object with the high-pressure fluid therein;
cleaning additive supply means for supplying a cleaning additive to be added to the high-pressure fluid at the time of cleaning to the high-pressure fluid; and
a piping system through which the high-pressure fluid containing the cleaning additive is supplied into the high-pressure vessel or discharged from the high-pressure vessel,
wherein at least the surfaces of portions in contact with the cleaning additive on an upstream side of the high-pressure vessel of the piping system and a portion in contact with the cleaning additive of the high-pressure vessel are made of a Fe-based alloy containing more than 20 mass % of Cr.

2. The cleaning apparatus of claim 1, wherein the cleaning additive is hydrogen fluoride.

3. The cleaning apparatus of claim 1, wherein substantially all the portions in contact with the cleaning additive of the high-pressure vessel and the piping system are made of a Fe-based alloy containing more than 20 mass % of Cr.

4. The cleaning apparatus of claim 1, wherein the surfaces of portions in contact with the cleaning additive of the high-pressure vessel and the piping system are coated with a Fe-based alloy containing more than 20 mass % of Cr.

5. An apparatus for cleaning an object to be cleaned with a high-pressure fluid, comprising:
a high-pressure vessel for cleaning the object with the high-pressure fluid therein;
cleaning additive supply means for supplying a cleaning additive to be added to the high-pressure fluid at the time of cleaning to the high-pressure fluid; and
a piping system through which the high-pressure fluid containing the cleaning additive is supplied into the high-pressure vessel or discharged from the high-pressure vessel,
wherein at least the surfaces of portions in contact with the cleaning additive on an upstream side of the high-pressure vessel of the piping system and a portion in contact with the cleaning additive of the high-pressure vessel are made of a Ni-based alloy containing more than 40 mass % of Cr.

6. The cleaning apparatus of claim 5, wherein the cleaning additive is hydrogen fluoride.

7. The cleaning apparatus of claim 5, wherein substantially all the portions in contact with the cleaning additive of the high-pressure vessel and the piping system are made of a Ni-based alloy containing more than 40 mass % of Cr.

8. The cleaning apparatus of claim 5, wherein the surfaces of portions in contact with the cleaning additive of the high-pressure vessel and the piping system are coated with a Ni-based alloy containing more than 40 mass % of Cr.

9. A high-pressure vessel for cleaning an object to be cleaned with a high-pressure fluid therein, wherein
at least the surfaces of portions in contact with the high-pressure fluid of the high-pressure vessel are made of a Fe-based alloy containing more than 20 mass % of Cr.

10. A high-pressure vessel for cleaning an object to be cleaned with a high-pressure fluid therein, wherein
at least the surfaces of portions in contact with the high-pressure fluid of the high-pressure vessel are made of a Ni-based alloy containing more than 40 mass % of Cr.
